(19) United States
(12) Patent Application Publication
(10) Pub. No.: US 2019/0104326 A1
(43) Pub. Date: Apr. 4, 2019

(54) CONTENT SOURCE DESCRIPTION FOR IMMERSIVE MEDIA DATA

(71) Applicant: QUALCOMM Incorporated, San Diego, CA (US)

(72) Inventors: Thomas Stockhammer, Bergen (DE); Ye-Kui Wang, San Diego, CA (US); Nikolai Konrad Leung, San Francisco, CA (US)

(21) Appl. No.: 16/149,690

(22) Filed: Oct. 2, 2018

Related U.S. Application Data
(60) Provisional application No. 62/567,661, filed on Oct. 3, 2017.

(51) Int. Cl. H04N 21/2343; H04L 29/06; H04N 21/61

(52) U.S. Cl. CPC H04N 21/2343; H04N 21/6125; H04L 65/601; H04L 65/608

(57) ABSTRACT

An example device for transferring media data including immersive media data includes a memory configured to store the media data, and one or more processors implemented in circuitry and configured to transfer metadata that systematically describes different formatting options for the immersive media data, process data representing one or more of the formatting options that a client device supports for rendering the immersive media data, and transfer the immersive media data having one of the formatting options that the client device supports. The device may be a server that sends the metadata and the media data to the client device, or the client device that receives the metadata and the media data. The client device may further configure a rendering environment according to the one of the formatting options to render the immersive media data.

This application claims the benefit of U.S. Provisional Application No. 62/567,661, filed Oct. 3, 2017, the entire content of which is hereby incorporated by reference.

### TECHNICAL FIELD

This disclosure relates to storage and transport of encoded media data, such as video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques related to processing and transmission (e.g., sending and/or receiving or retrieving) media data. In particular, the techniques of this disclosure include processing (e.g., generating and/or interpreting) content source descriptions for immersive data. This disclosure describes techniques for systematically describing different source models for immersive media. The different source models may include any or all of two-dimensional, fisheye, spherical projected 360, packed multi-cameras, and individual multi cameras. The description techniques may be based on and used for network transmission systems, e.g., systems that use Session Description Protocol (SDP)/Real-time Transport Protocol (RTP) based delivery and signaling, Dynamic Adaptive Streaming over HTTP (DASH)/HTTP based delivery and signaling, generic deliver and signaling, and so on. Such techniques may be used, e.g., for virtual reality (VR), augmented reality, and/or 360-degree video applications.

In one example, a method of sending media data including immersive media data includes sending metadata that systematically describes different formatting options for the immersive media data to a client device, receiving, from the client device, data representing one or more of the formatting options that the client device supports for rendering the immersive media data, selecting a formatting option of the one or more of the formatting options that the client device supports, and sending the immersive media data having the selected formatting option to the client device.

In another example, a method of retrieving media data including immersive media data includes receiving, by a client device, metadata that systematically describes different formatting options for the immersive media data from a server device, determining, by the client device, one or more of the formatting options that the client device supports for rendering the immersive media data, sending, by the client device, to the server device, data representing the one or more of the formatting options that the client device supports for rendering the immersive media data, retrieving, by the client device, the immersive media data having one of the formatting options, and configuring, by the client device, a rendering environment according to the one of the formatting options to render the immersive media data.

In another example, a device for transferring media data including immersive media data includes a memory configured to store the media data, and one or more processors implemented in circuitry and configured to transfer metadata that systematically describes different formatting options for the immersive media data, process data representing one or more of the formatting options that a client device supports for rendering the immersive media data, and transfer the immersive media data having one of the formatting options that the client device supports.

In another example, a computer-readable storage medium has stored thereon instructions that, when executed, cause a processor to transfer metadata that systematically describes different formatting options for immersive media data included in media data, process data representing one or more of the formatting options that a client device supports for rendering the immersive media data, and transfer the immersive media data having one of the formatting options that the client device supports.

In another example, device for transferring media data including immersive media data includes means for transferring metadata that systematically describes different formatting options for the immersive media data, means for processing data representing one or more of the formatting options that a client device supports for rendering the immersive media data, and means for transferring the immersive media data having one of the formatting options that the client device supports.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a conceptual diagram illustrating an example region-wise packing process according to the Omnidirectional MediA Format (OMAF) draft specification.

FIG. 3 is a conceptual diagram illustrating spherical coordinates related to spherical projection.

FIG. 4 is a block diagram illustrating an example set of components of a retrieval unit.

FIG. 5 is a conceptual diagram illustrating elements of example multimedia content.

FIG. 6 is a block diagram illustrating elements of an example video file, which may correspond to a segment of a representation.

FIG. 7 is a flowchart illustrating an example method for transferring media data including immersive media data between a server device and a client device according to the techniques of this disclosure.

### DETAILED DESCRIPTION

The techniques of this disclosure may be applied to video files conforming to video data encapsulated according to any of ISO base media file format (ISOBMFF), extensions to ISOBMFF, Scalable Video Coding (SVC) file format, Advanced Video Coding (AVC) file format, High Efficiency Video Coding (HEVC) file format, Third Generation Partnership Project (3GPP) file format, and/or Multiview Video Coding (MVC) file format, or other video file formats. A draft of ISO BMFF is specified in ISO/IEC 14496-12, available from phenix.int-evey.fr/mpeg/doc_end_user/documents/111_Geneva/wg11/w15177-v6-w15177.zip. A draft of another example file format, MPEG-4 file format, is specified in ISO/IEC 14496-15, available from wg11.sc29.org/doc_end_user/documents/115_Geneva/wg11/w16169-v2-w16169.zip.

ISOBMFF is used as the basis for many codec encapsulation formats, such as the AVC file format, as well as for many multimedia container formats, such as the MPEG-4 file format, the 3GPP file format (3GP), and the digital video broadcasting (DVB) file format.

In addition to continuous media, such as audio and video, static media, such as images, as well as metadata can be stored in a file conforming to ISOBMFF. Files structured according to the ISOBMFF may be used for many purposes, including local media file playback, progressive downloading of a remote file, segments for Dynamic Adaptive Streaming over HTTP (DASH), containers for content to be streamed and its packetization instructions, and recording of received real-time media streams.

A box is an elementary syntax structure in ISOBMFF, including a four-character coded box type, the byte count of the box, and the payload. An ISOBMFF file includes a sequence of boxes, and boxes may contain other boxes. According to ISOBMFF, a Movie box (“moov”) contains the metadata for the continuous media streams present in the file, each one represented in the file as a track. Per ISOBMFF, metadata for a track is enclosed in a Track box (“trak”), while the media content of a track is either enclosed in a Media Data box (“mdat”) or provided directly in a separate file. The media content for tracks includes a sequence of samples, such as audio or video access units.

ISOBMFF specifies the following types of tracks: a media track, which contains an elementary media stream, a hint track, which either includes media transmission instructions or represents a received packet stream, and a timed metadata track, which comprises time-synchronized metadata.

Although originally designed for storage, the ISOBMFF has proven to be very valuable for streaming, e.g., for progressive download or DASH. For streaming purposes, movie fragments defined in ISOBMFF can be used.

The metadata for each track includes a list of sample description entries, each providing the coding or encapsulation format used in the track and the initialization data needed for processing that format. Each sample is associated with one of the sample description entries of the track.

The ISOBMFF enables specifying sample-specific metadata with various mechanisms. Specific boxes within the Sample Table box (“stbl”) have been standardized to respond to common needs. For example, a Sync Sample box (“stss”) is used to list the random access samples of the track. The sample grouping mechanism enables mapping of samples according to a four-character grouping type into groups of samples sharing the same property specified as a sample group description entry in the file. Several grouping types have been specified in the ISOBMFF.

Virtual reality (VR) is the ability to be virtually present in a virtual, non-physical world created by the rendering of natural and/or synthetic images and sounds correlated by movements of an immersed user, allowing interaction with that virtual world. With recent progress made in rendering devices, such as head mounted displays (HMD) and VR video (often also referred to as 360-degree video) creation, a significant quality of experience can be offered. VR applications include gaming, training, education, sports video, online shopping, entrainment, and so on.

A typical VR system includes the following components and steps:
1) A camera set, which typically includes multiple individual cameras pointing in different directions, ideally collectively covering all viewpoints around the camera set.
2) Image stitching, where video pictures taken by the multiple individual cameras are synchronized in the time domain and stitched in the space domain, to be a spherical video, but mapped to a rectangular format, such as equirectangular (like a world map) or cube map.
3) The video in the mapped rectangular format is encoded/compressed using a video codec, e.g., H.265/HEVC or H.264/AVC.
4) The compressed video bitstream(s) may be stored and/or encapsulated in a media format and transmitted (possibly only the subset covering the area being seen by a user, sometimes referred to as the viewport) through a network to a receiving device (e.g., a client device).
5) The receiving device receives the video bitstream(s) or part thereof, possibly encapsulated in a file format, and sends the decoded video signal or part thereof to a rendering device (which may be included in the same client device as the receiving device).
6) The rendering device can be, e.g., an HMD, which can track head movement and even eye move moment, and may render the corresponding part of the video such that an immersive experience is delivered to the user.

Omnidirectional MediA Format (OMAF) is being developed by the Moving Pictures Experts Group (MPEG) to define a media format that enables omnidirectional media applications, focusing on VR applications with 360-degree video and associated audio. OMAF specifies a list of projection methods that can be used for conversion of a spherical or 360-degree video into a two-dimensional rectangular video, followed by how to store omnidirectional media and the associated metadata using the ISO base media file format (ISOBMFF) and how to encapsulate, signal, and stream omnidirectional media using dynamic adaptive streaming over HTTP (DASH), and finally, which video and audio codecs, as well as media coding configurations, can be used for compression and playback of the omnidirectional media signal. OMAF is to become ISO/IEC 23090-2, and a draft specification is available to MPEG members from wg11.sc29.org/doc_end_user/documents/119_Torino/wg11/16950.zip.

In HTTP streaming protocols, such as DASH, frequently used operations include HEAD, GET, and partial GET. The HEAD operation retrieves a header of a file associated with a given uniform resource locator (URL) or uniform resource name (URN), without retrieving a payload associated with the URL or URN. The GET operation retrieves a whole file associated with a given URL or URN. The partial GET operation receives a byte range as an input parameter and retrieves a continuous number of bytes of a file, where the number of bytes correspond to the received byte range. Thus, movie fragments may be provided for HTTP streaming, because a partial GET operation can get one or more individual movie fragments. In a movie fragment, there can be several track fragments of different tracks. In HTTP streaming, a media presentation may be a structured collection of data that is accessible to the client. The client may request and download media data information to present a streaming service to a user.

DASH is specified in ISO/IEC 23009-1, and is a standard for HTTP (adaptive) streaming applications. ISO/IEC 23009-1 mainly specifies the format of the media presentation description (MPD), also known as a manifest or manifest file, and media segment formats. The MPD describes the media available on a server and allows a DASH client to autonomously download an appropriate media version at an appropriate media time.

In the example of streaming 3GPP data using HTTP streaming, there may be multiple representations for video and/or audio data of multimedia content. As explained below, different representations may correspond to different coding characteristics (e.g., different profiles or levels of a video coding standard), different coding standards or extensions of coding standards (such as multiview and/or scalable extensions), or different bitrates. The manifest of such representations may be defined in an MPD data structure. A media presentation may correspond to a structured collection of data that is accessible to an HTTP streaming client device. The HTTP streaming client device may request and download media data information to present a streaming service to a user of the client device. A media presentation may be described in the MPD data structure, which may be periodically updated.

A media presentation may contain a sequence of one or more Periods. Each period may extend until the start of the next Period, or until the end of the media presentation, in the case of the last period. Each period may contain one or more representations for the same media content. A representation may be one of a number of alternative encoded versions of audio, video, timed text, or other such data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

A typical procedure for DASH based HTTP streaming includes the following steps:
1) A DASH client obtains the MPD of a streaming content, e.g., a movie. The MPD includes information on different alternative representations, e.g., bit rate, video resolution, frame rate, audio language, of the streaming content, as well as URLs of the HTTP resources (the initialization segment and the media segments).
2) Based on information in the MPD and local information available to the DASH client, e.g., network bandwidth, decoding/display capabilities, and user preferences, the DASH client requests the desired representation(s), one segment (or a part thereof) at a time.
3) When the DASH client detects a network bandwidth change, it requests segments of a different representation with a better-matching bitrate, ideally starting from a segment that starts with a random access point.

During an HTTP streaming “session,” to respond to a user request to seek backward to a past position or forward to a future position, the DASH client requests past or future segments starting from a segment that is close to the desired position and that ideally starts with a random access point. The user may also request to fast-forward the content, which may be realized by requesting data sufficient for decoding only intra-coded video pictures or only a temporal subset of the video stream.

Video data may be encoded according to a variety of video coding standards. Such video coding standards include ITU-T H.261, ISO/IEC MPEG-1 Visual, ITU-T H.262 or ISO/IEC MPEG-2 Visual, ITU-T H.263, ISO/IEC MPEG-4 Visual, ITU-T H.264 or ISO/IEC MPEG-4 AVC, including its Scalable Video Coding (SVC) and Multiview Video Coding (MVC) extensions, and High-Efficiency Video Coding (HEVC), also known as ITU-T H.265 and ISO/IEC 23008-2, including its scalable coding extension (i.e., scalable high-efficiency video coding, SHVC) and multiview extension (i.e., multiview high efficiency video coding, MV-HEVC).

This disclosure describes various constraints that may be added to the OMAF draft specification and/or other standards (e.g., DASH, ISO BMFF, HEVC, or the like) to improve processing of media data (such as encapsulation, decapsulation, encoding, and/or decoding). In general, such constraints allow devices to infer characteristics of a media bitstream, such that events that cannot happen according to the constraint need not be accounted for, e.g., by a data assembler/constructor (such as a content preparation device or server device) or by a data parser (such as a client device, e.g., a file processing unit or decapsulation unit). For example, if a constraint specifies that certain data may only be present when a condition is true, if the condition is false, the constrained data need not be processed. Additionally or alternatively, if the data is present, then the stated condition can be inferred to be true. More particularly, a context-free grammar corresponding to a bitstream may be formed that accounts for the various conditions to specify whether subsequent data corresponds to the constrained data or not. Likewise, a data generation unit and a data parsing unit may be implemented and configured according to the context-free grammar.

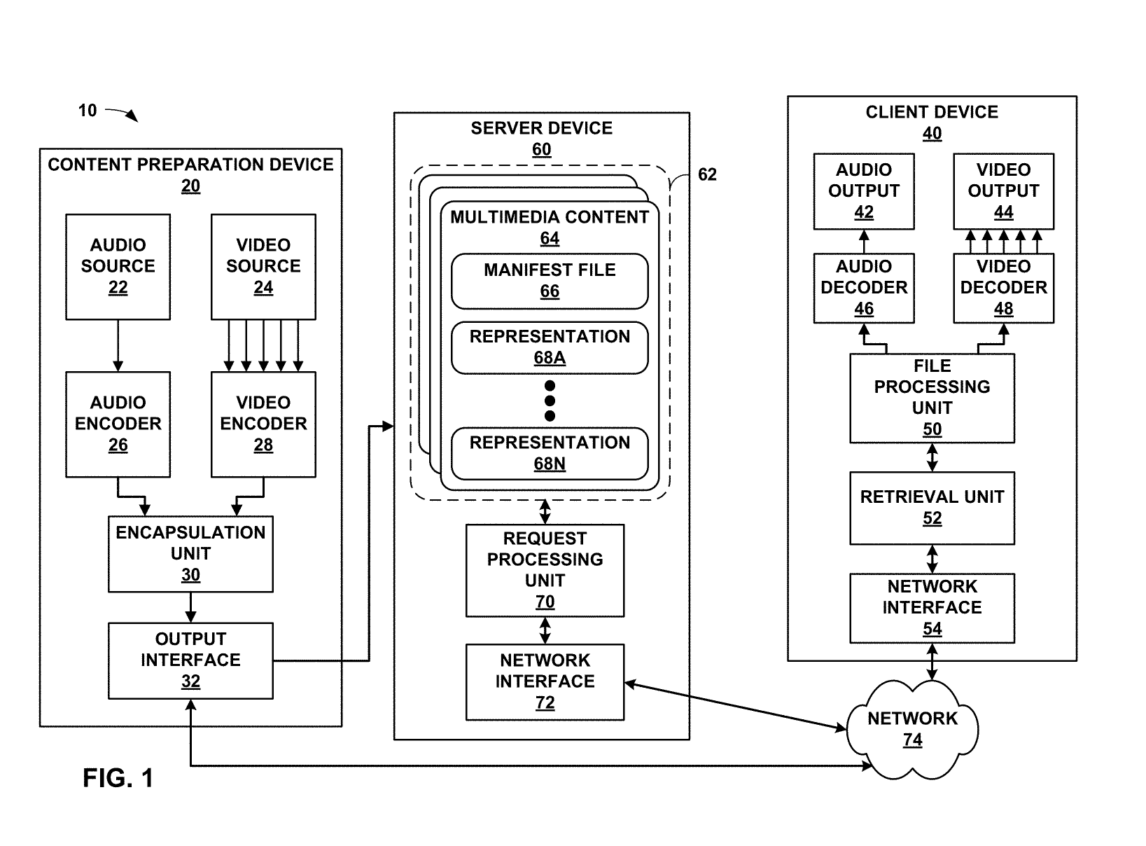

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

Many video coding standards, such as ITU-T H.264/Advanced Video Coding (AVC) and ITU-T H.265/High Efficiency Video Coding (HEVC), define the syntax, semantics, and decoding process for error-free bitstreams, any of which conform to a certain profile or level. Video coding standards typically do not specify the encoder, but the encoder is tasked with guaranteeing that the generated bitstreams are standard-compliant for a conforming decoder. In the context of video coding standards, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and block processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define limitations on the number of macroblocks that need to be processed, decoded picture buffer (DPB) size, coded picture buffer (CPB) size, vertical motion vector range, maximum number of motion vectors per two consecutive MBs, and whether a B-block can have sub-macroblock partitions less than 8×8 pixels. In this manner, a decoder may determine whether the decoder is capable of properly decoding the bitstream.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture, hence coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points. In addition, encapsulation unit 30 may form a manifest file, such as a media presentation descriptor (MPD) that describes characteristics of the representations. Encapsulation unit 30 may format the MPD according to extensible markup language (XML).

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1, server device 60 includes storage medium 62 that stores various multimedia contents 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage medium 62. For example, request processing unit 70 may implement hypertext transfer protocol (HTTP) version 1.1, as described in RFC 2616, “Hypertext Transfer Protocol—HTTP/1.1,” by R. Fielding et al, Network Working Group, IETF, June 1999. That is, request processing unit 70 may be configured to receive HTTP GET or partial GET requests and provide data of multimedia content 64 in response to the requests. The requests may specify a segment of one of representations 68, e.g., using a URL of the segment. In some examples, the requests may also specify one or more byte ranges of the segment, thus comprising partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally or alternatively, request processing unit 70 may be configured to deliver media data via a broadcast or multicast protocol, such as eMBMS. Content preparation device 20 may create DASH segments and/or sub-segments in substantially the same way as described, but server device 60 may deliver these segments or sub-segments using eMBMS or another broadcast or multicast network transport protocol. For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

As illustrated in the example of FIG. 1, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bitrate, and other descriptive characteristics of representations 68. Client device 40 may retrieve the MPD of a media presentation to determine how to access segments of representations 68.

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

Network interface 54 may receive and provide data of segments of a selected representation to retrieval unit 52, which may in turn provide the segments to file processing unit 50. File processing unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, retrieval unit 52, and file processing unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, retrieval unit 52, and/or file processing unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to file processing unit 50, via retrieval unit 52. File processing unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

In accordance with the techniques of this disclosure, as discussed in greater detail below, server device 60 and/or content preparation device 20 may prepare and send metadata describing immersive media content of media data to be sent to client device 40. The immersive media content may be available for a variety of different formatting options, such as any or all of two-dimensional video data, multistream video data, fisheye video data, projected 360-degree video data, or packed video data. Retrieval unit 52 of client device 40 may use the description of the immersive media content to determine one or more of the formatting options that client device 40 supports. Retrieval unit 52 may then provide data indicating which of these formatting options are supported to, e.g., server device 60. Server device 60 may then select immersive media content having one of the supported formatting options and send the selected immersive media content to client device 40. Client device 40 may further configure a rendering environment, e.g., of video output 44, to render the immersive media content.

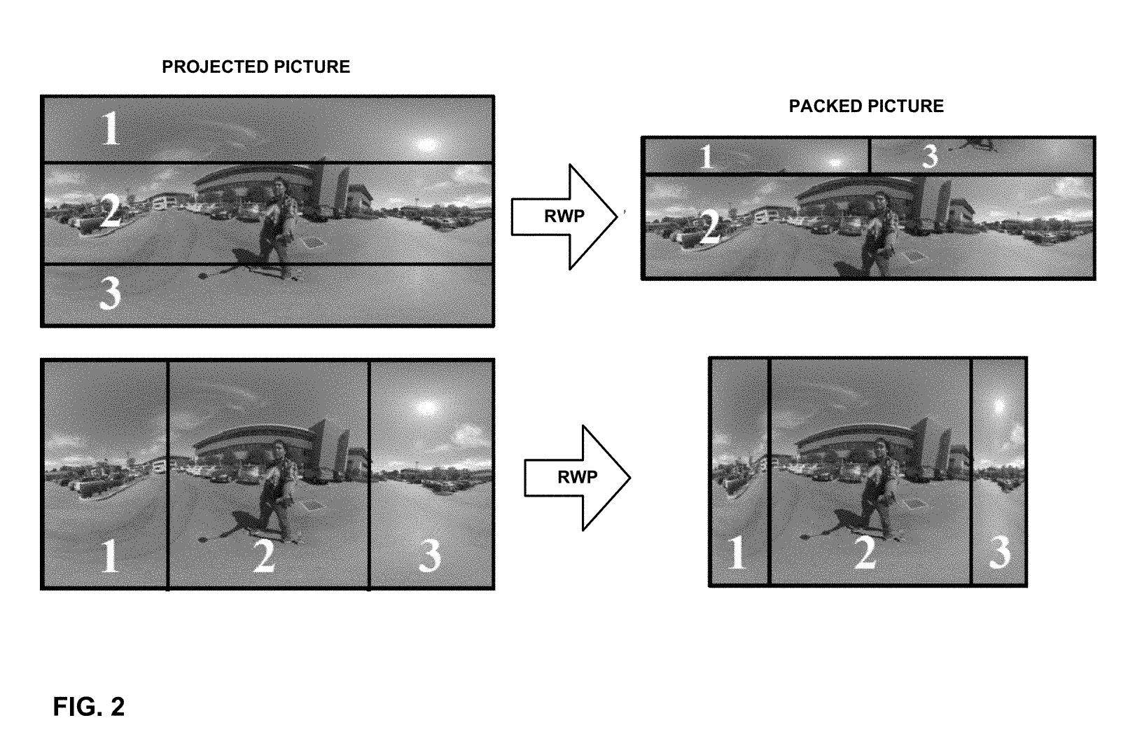

FIG. 2 is a conceptual diagram illustrating an example region-wise packing process according to the OMAF draft specification. The OMAF draft specification specifies a mechanism called region-wise packing (RWP). RWP enables manipulations (resize, reposition, rotation, and mirroring) of any rectangular region of a projected picture. RWP can be used to generate an emphasis on a specific viewport orientation or circumvent weaknesses of projections such as oversampling towards the poles in ERP. The latter is depicted in the top of FIG. 2, where the areas near the poles of the sphere video are reduced in resolution. The bottom of FIG. 2 depicts an example for an emphasized viewport orientation.

Referring again to FIG. 1, information on RWP is signalled in the RWP box, for which the RegionWisePackingStruct that specifies the information carried in the RWP box is specified in clause 7.2.3 of the latest OMAF draft text.

Boyce et al., “HEVC Additional Supplemental Enhancement Information (Draft 3),” JCT-VC of ITU-T SG 16 WP 3 and ISO/IEC JTC 1/SC 29/WG 11, Torino, IT, 15-21 Jul. 2017, document JCTVC-AB1005-v1 (available at phenix.int-evey.fr/jct/doc_end user/documents/28_Torino/wg11/JCTVC-AB1005-v1.zip) includes OMAF-related SEI messages, including equirectangular projection (ERP) SEI message, cubemap projection (CMP) SEI message, region-wise packing (RWP) SEI message, and omnidirectional viewport SEI message.

3GPP SA4 is working on Framework for Live Uplink Streaming (FLUS), which targets at specifying some immersive media services that involve uplink immersive media streaming. A description of FLUS is available in the document S4-AHM363 (available at www.3gpp.org/FTP/tsg_sa/WG4_CODEC/Ad-hoc_MTSI/Docs/S4-AHM363.zip), including additions documented in S4-170843 (ftp.3gpp.org/tsg_sa/WG4_CODEC/TSGS4_95/Docs/S4-170843.zip).

However, this disclosure recognizes that existing solutions for FLUS services lack methods for systematic description of different source models for immersive media. The different immersive video source models include 2D, fisheye, spherical projected 360, packed multi-cameras, and individual multi-cameras. The description methods are needed for systems that use SDP/RTP based delivery and signalling, DASH/HTTP based delivery and signalling, or based on any other delivery and signalling.

This disclosure describes various techniques that may address these issues. These techniques may be performed by any or all of content preparation device 20, server device 60, and/or client device 40. This disclosure describes various techniques for systematically describing different source models for immersive media. The different immersive video source models include two-dimensional (2D), fisheye, spherical projected 360, packed multi-cameras, and individual multi-cameras. The description methods may be based on and used for systems that use SDP/RTP based delivery and signalling, DASH/HTTP based delivery and signalling, generic delivery and signalling, and so on. System 10 represents an example of such a system.

In general, certain aspects of the techniques of this disclosure include:
A systematic description of different source models for immersive media, e.g., by content preparation device 20 and/or server device 60. The systematic description may be included in manifest file 66, e.g., a media presentation description (MPD), or in session description protocol (SDP) data.
A systematic description of different video source models for immersive media, e.g., by content preparation device 20 and/or server device 60, namely:
   2D
   Fish-eye,
   Spherical projected 360
   Packed multi-cameras
   Individual multi-cameras
For SDP/RTP based signaling, e.g., by content preparation device 20 and/or server device 60:
   Fish-eye:
      Use an inband SEI message that signals fish-eye
      Use a new SDP parameter that indicates the scheme type (scheme defines the processing requirements), or
      Use a new SDP parameter that indicates the presence of certain SEI messages
   Projected 360 video
      Use an inband SEI message that signals projection, coverage and stereo mode
      Use a new SDP parameter that indicates the scheme type (scheme defines the processing requirements), or
      Use a new SDP parameter that indicates the presence of certain SEI messages
   Packed Video content
      Use an inband SEI message that maps regions to external ids
      Use a new SDP parameter that provides configuration information and associates each id to dedicated stream in a configuration
      Use a new SDP parameter that indicates the presence of certain SEI messages
   For audio
      Use an inband metadata that provides the mapping of the content to the 3D space
      Use a new SDP parameter that indicates the contained metadata
   For A/V alignment
      Do a rotation signaling in one of the media components
      Do a new RTCP SR to provide a spatial alignment between audio and video
For generic signaling, e.g., by content preparation device 20 and/or server device 60
   Fish-eye:
      Use an inband SEI message that signals fish-eye
      Use system level signalling that indicates the scheme type (scheme defines the processing requirements), or
      Use system level signalling that indicates the presence of certain SEI messages
   Projected 360 video
      Use an inband SEI message that signals projection, coverage and stereo mode
      Use system level signalling that indicates the scheme type (scheme defines the processing requirements), or
      Use system level signalling that indicates the presence of certain SEI messages
   Packed Video content
      Use an inband SEI message that maps regions to external ids
      Use system level signalling that provides configuration information and associates each id to dedicated stream in a configuration
      Use system level signalling that indicates the presence of certain SEI messages
   For audio
      Use an inband metadata that provides the mapping of the content to the 3D space
      Use system level signalling that indicates the contained metadata
   For A/V alignment
      Do a rotation signaling in one of the media components
      Do an alignment signaling on system level
Use of all of this in an immersive media uplink, e.g., between content preparation device 20 and server device 60 or between server device 60 and network 74.

In one example, content preparation device 20 and/or server device 60 may be configured to use a content model that includes source bundles. Source bundles may represent a collection of sources that have a relationship. Source bundles may, for example, include all cameras at an event (e.g., all cameras at a formula one track, including those mounted on a car). A “source” may generally refer to a data providing entity, such as a camera, microphone, or the like. The signals produced by the sources are largely independent, but are time-synchronized.

In one example, each source bundle includes at most one audio and at most one video source, and in addition, content preparation device 20 and/or server device 60 may provide metadata for the source bundle. Such metadata may include:
Video
   single camera 2D content
   Fish-eye camera, producing one stream
   Pre-stitched at the source (may also work with all of the above cameras) and 3D content is uploaded
   Cloud Stitching: Multiple cameras (up to 8), like Ozo, or GoPro (6), Google Jump
      Each camera stream is up-streamed individually as 2D video
      Fixed in relationship and well-described geometry (maybe only type is sufficient and the numbering with streams)
      Output signals are assumed to be synchronized and calibrated
      Stitching Metadata is proprietary
   Packed content for stitching: similar to previous, but each of the view are provided as a packed region
   For each of those the describing metadata is present as well as the encoding and delivery
Audio Capturing devices
   Combination of spatial signals and format is generated at sink
      A combination of mono signals that are well described by metadata (such as ambisonics number)
      Information on practical implementation and products would be good
      ADM describes this
   Individual Mono Audio sources generated by a well-defined microphone array
      Each mic stream is upstreamed individually as mono signal
      Fixed in relationship and well-described geometry (maybe only type is sufficent and the numbering with streams)
      Capture Output signals are assumed to be synchronized and calibrated
      The mixing metadata is proprietary
   Distributed microphone arrays
      Similar as above, but you need detailed spatial coordinates, etc. with each mic
Metadata
   Device or sensor location which may change dynamically
   Time of the day (recording tracking)
   Recording information and and
   Heatmaps
   Director cut
   Region of Interest
   Etc.

Table 1 below provides an overview of descriptive metadata that content preparation device 20 and/or server device 60 may provide, e.g., to client device 40, via network 74.

TABLE 1
Overview of Descriptive Metadata
addressing example use cases above

Type

Video

| | |
|---|---|
| 2D-Video | Codec-Independent code points |
| | (ISO/IEC 23001-8) |
| | Video Elementary Stream: SPS/PPS/VUI |
| | File Format Data for video handler |
| | DASH MPD |
| | SDP parameters for video in MTSI |
| Fisheye Video | SEI message [tbc] |
| | OMAF metadata |
| Projected 360 Video | SEI messages in Elementary stream: ERP, |
| | Frame Packing Arrangement, etc. |
| | OMAF Metadata |
| | VR-IF Guidelines |
| Packed Video Content | SEI messages for region-wise packing |
| | OMAF metadata |
| Multistream Video | DASH MPD with Viewpoint |
| | SDP parameters |

Audio

| | |
|---|---|
| 2D Audio | Codec-Independent code points |
| | File format for audio handler |
| | Audio Definition Model |
| 3D Audio | Codec-Independent code points |
| | ITU-R Audio Definition Model (ADM) |
| | MPEG-H audio metadata |
| | VR |
| Multi-microphone | tbd |

Metadata

| | |
|---|---|
| Location | 3GPP Metadata Track |
| | Timed metadata in MPEG |
| | (ISO/IEC 23001-9) |
| Timing | File Format |
| | SDP |
| Processing Information | Tbd |
| Director's Cut | OMAF |
| Heatmap | OMAF |

Synchronization and Alignment

| | |
|---|---|
| Synchronization | RTP and RTCP sender reports |
| | File format tracks |
| | DASH presentation time offset |
| Spatial Alignment | Coordinate system alignment (tbd) |
| | Rotation |

In order to properly describe the source content needs to be presented. Relevant parameters are discussed below.

2D video may be described by the parameters shown in Table 2 below:

TABLE 2-2D
Video Parameters

| Parameter | Explanation | DataType | Examples |
|---|---|---|---|
| PixelDimensions | Width and | Integer x | 4096 × 2048, |
| | Height of the | Integer | 1920 × 1080, |
| | luma video | | etc. |
| | reference | | |
| | frame in | | |
| | pixels. | | |
| FrameRate | Frame Rate | Integer | 25, 30, 48, 50, 60, |
| | in frames | | 90, 120 |
| | per second | | |
| CroppingInformation | Cropping | Integer, | can be any |
| | Information | Integer, | information in |
| | top, right, | Integer, | pixel |
| | bottom, left | Integer | |
| PictureAspectRatio | Picture | Integer: | 2:1 |
| | aspect ratio | Integer | |
| ChromaFormat | Chroma | Enum | YCbCr |
| | format | | |
| ColourSampling | Colour | Enum | 4:2:0 |
| | sampling | | |
| | format | | |
| SampleAspectRatio | Sample | Integer: | 1:1 |
| | aspect ratio | Integer | |
| BitDepth | Bit depth | Integer | 8, 10 |
| ColourPrimaries | Colour | Integer, | 1, 1: ITU-R BT.709: |
| | primaries | Integer | colour_primaries = 1, |
| | | | matrix_coefficients = |
| | | | 1 |
| | | | 9, 9: ITU-R BT.2100 |
| | | | colour primaries and |
| | | | non-constant |
| | | | luminance matrix |
| | | | coefficients, i.e., |
| | | | colour_primaries = 9, |
| | | | matrix_coefficients |
| TransferFunction | Transfer | Integer | 1: BT.709 |
| | function | | 14: SDR BT.2020 |
| | | | 16: HDR PQ10 |
| Encoding Format | Codec | String | H.264/AVC + profile |
| | | | and level |
| | | | H.265/HEVC + |
| | | | profile level |

Spherical video may be described by the parameters of Table 3 below. The spherical video techniques of this disclosure are generally described with respect to the model defined in Draft Amd.3 of H.265/HEVC as discussed above.

One issue related to spherical video is of presentation of spherical video (possibly in stereo mode) in a 2D texture mode. 2D texture can be used for regular 2D distribution using the parameters defined in Table 3 below.

TABLE 3
Spherical Video Parameters
Spherical Video

| | | | |
|---|---|---|---|
| Spherical | Flag indicating if the | Boolean | Yes |
| | video is a spherical | | |
| | video | | |
| ProjectionType | Projection type used | Enum | Equirectangular |
| | in the video frames | | |
| StereoMode | Description of | Enum | mono, stereo-left, |
| | stereoscopic 3D | | stereo-right |
| | layout | | |
| Coverage | Coverage | More details | |
| | Parameters of the | below | |
| | video | | |
| Rotation | Rotation Parameters | More details | |
| | | below | |

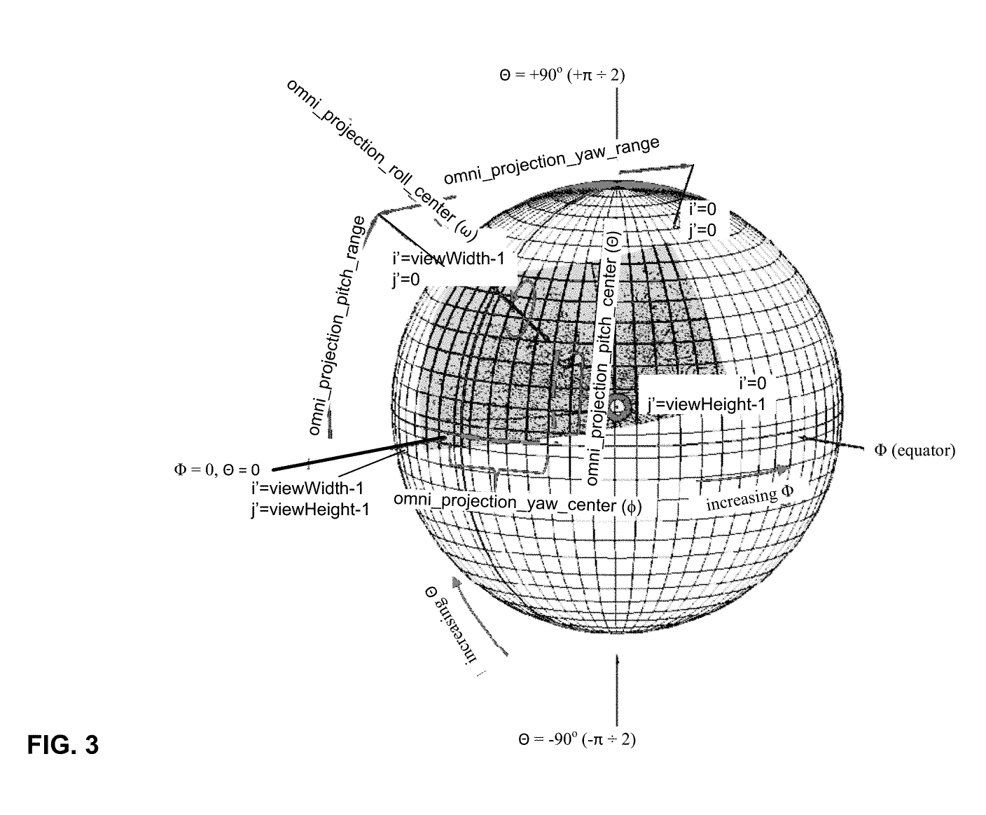

FIG. 3 is a conceptual diagram illustrating spherical coordinates related to spherical projection. In particular, spherical coordinates of FIG. 3 include ϕ, θ with yaw, pitch, and roll of the region of a sphere covered by a cropped output picture relative to the equator and 0 meridian of the sphere.

The mapping of the colour samples of 2D texture images onto a spherical coordinate space in angular coordinates (φ, θ) for use in omnidirectional video applications for which the viewing perspective is from the origin looking outward toward the inside of the sphere. The spherical coordinates are defined so that φ is the azimuth (longitude, increasing eastward) and θ is the elevation (latitude, increasing northward) as depicted in FIG. 3.

Rotation angles yaw (α), pitch (β), and roll (γ) are also used in the specification of these semantics.

Relative to an (x, y, z) Cartesian coordinate system, yaw expresses a rotation around the z (vertical, up) axis, pitch rotates around the y (lateral, side-to-side) axis, and roll rotates around the x (back-to-front) axis. Rotations are extrinsic, i.e., around x, y, and z fixed reference axes. The angles increase clockwise when looking from the origin towards the positive end of an axis.

Assume a signal with the following parameters is provided:
Projection is ERP with the coordinate system and mapping according to FIG. 3.
The frame rate of the signal is provided as FrameRate
The full reference 360 video has spatial resolution FullWidthPixel times FullHeightPixel with picture aspect ratio 2:1
The signal may follow the mono or stereo. If stereo, the signal is provided separately per eye. The type is expressed in the StereoMode parameter.
The signal may have a restricted coverage expressed in the Coverage Parameter, if present, in the spherical domain expressed as follows:
   AzimuthMin specifies the minimum azimuth value of the coverage sphere region in the range of −360 to 360 degrees.
   AzimuthMax specifies the maximum azimuth value of the coverage sphere region in the range of −360 to 360 degrees. This value is greater than AzimuthMin.
   ElevationMin specifies the minimum elevation value of the coverage sphere region in the range of −90 to 90 degrees.
   ElevationMax specifies the maximum elevation value of the coverage sphere region, in in the range of −90 to 90 degrees.
The signal may have prerotation expressed in the Rotation parameter, if present, in the spherical domain expressed as follows
   RotationYaw specifies the value of the yaw rotation angle in the range of −180 to 180 degrees. When not present, the value is inferred to be equal to 0.
   RotationPitch specifies the value of the pitch rotation angle in the range of −90 to 90 degrees. When not present, the value is inferred to be equal to 0.
   RotationRoll specifies the value of the roll rotation angle in the range of −180 to 180 degrees. When not present, the value is inferred to be equal to 0.
If not the full signal is provided but a cropped version of it, then this is expressed by the Cropping Parameter with the four following values
   Top: the number of pixel cropped by on the top compared to the full pixel height.
   Right: the number of pixel cropped by on the right compared to the full pixel height.
   Bottom: the number of pixel cropped by on the bottom compared to the full pixel height.
   Left: the number of pixel cropped by on the left compared to the full pixel height.
The provided image sequence therefore has a luma component with
   Width being FullWidthPixel−(Cropping.Left+Cropping.Right)
   Height being FullWidthPixel−(Cropping.Top+Cropping.Bottom)
The Cropping parameter may be chosen such that all pixels that are in coverage are included in the image.

The local projected sphere coordinates (φ, θ) for the sample location for the center point of a sample location (i, j) may be derived as follows:

φ=(AzimuthMin+(0.5−i÷FullWidthPixel)*(AzimuthMax−AzimuthMin))

θ=(ElevationMin+(0.5−j÷FullHeightPixel)*(ElevationMax−ElevationMin))

If the Rotation parameter is not present, then the global projected sphere coordinates (φ′, θ′) for the sample location for the centre point of a sample location (i, j) may be identical to the local sphere coordinates (φ, θ).

If the Rotation parameter is present with parameters Rotation Yaw (α), RotationPitch (β), RotationRoll (γ)—all in units of degrees—then the global projected sphere coordinates (φ′, θ′) for the sample location for the center point of a sample location (i, j) may be derived based on its the local sphere coordinates (φ, θ) as follows:

x₁=Cos(φ)*Cos(θ)

y₁=Sin(φ)*Sin(θ)

z₁=Sin(θ)

x₂=Cos(β)*Cos(γ)*x₁−Cos(β)*Sin(γ)*y₁+Sin(β)*z₁

y₂=(Cos(α)*Sin(γ)+Sin(α)*Sin(β)*Cos(γ))*x₁+(Cos(α)*Cos(γ)−Sin(α)*Sin(β)*Sin(γ))*y₁−Sin(α)*Cos(β)*z₁

z₂=(Sin(α)*Sin(γ)−Cos(α)*Sin(β)*Cos(γ))*x₁+(Sin(α)*Cos(γ)+Cos(α)*Sin(β)*Sin(γ))*y₁+Cos(α)*Cos(β)*z₁

φ′=A tan 2(y₂, x₂)*180≥π

θ′=A sin(z₂)*180≥π

The above content parameters may be mapped directly to the encoded signal, or a preprocessing may be applied such that the above parameters are adjusted.

Referring again to FIG. 1, content preparation device 20 and/or source device 60 may provide multistream video parameters for multistream parameters according to Table 4 below:

TABLE 4
Multistream Video Parameters

| Parameter | Explanation | DataType | Examples |
|---|---|---|---|
| Configuration | Provides a | URI | GoPro with exact |
| | unique | | parameters |
| | identifier for a | | Ozo with exact parameters |
| | configuration | | |
| NumberStreams | Number of | Integer | 2, 6, 8 |
| | streams that are | | |
| | provided | | |
| id | Unique | Integer | |
| | identifier of the | | |
| | stream within | | |
| | the | | |
| | configuration | | |
| 2D Video | Provides the | Integer | |
| Parameters | 2D video | | |
| | parameters for | | |
| | each stream | | |

Content preparation device 20 and/or source device 60 may provide packed video parameters for multistream parameters according to Table 5 below, which generally represents an example in which region-wise packing has been extended:

TABLE 5
Packing Video Parameters

| Parameter | Explanation | DataType | Examples |
|---|---|---|---|
| Configuration | Provides a | URI | GoPro with exact |
| | unique | | parameters |
| | identifier for a | | Ozo with exact |
| | configuration | | parameters |
| 2D Video Parameters | Provides the | Integer | |
| | 2D video | | |
| | parameters for | | |
| | each stream | | |
| NumberOfRegions | Number of | Integer | 2, 6, 8 |
| | regions that are | | |
| | provided | | |
| id | Unique | Integer | |
| | identifier of the | | |
| | stream within | | |
| | the | | |
| | configuration | | |

The different tracks may be synchronized in time and aligned in one coordinate system. Content preparation device 20 and/or server device 60 may provide metadata to client device 40 to provide this alignment.

In order to deliver metadata from sources to a sink device, several options exist. To consider a suitable delivery mechanism, a few aspects should be considered:
1) Is the metadata static (does not change within a session), semi-static (is typically static, but configuration can be changed) or dynamic (changes potentially with every sample of is time-dependent)
2) Is the metadata related to an entire source bundle, to one content source, or to one media component of a content source?
3) Is the metadata already defined properly in a transport system and can be re-used?
4) Does the metadata have to be accessed on certain protocol layers, for example
   a. For session establishment
   b. For capability negotiation
   c. In the rendering and display process
   d. Etc.

Also based on these considerations, for each protocol instantiation, the solution may be different, depending on the available functionalities.

Content preparation device 20 and/or server device 60 may provide metadata in different instances. Examples are provided in Table 6 below:

TABLE 6
Example Carriage Options of Metadata

| Container | Usage | Example |
|---|---|---|
| SDP attribute/ | Metadata that is static for | Camera configuration |
| parameter | the FLUS media session | |
| RTP header | Metadata that needs to be | Geo-location/orientation |
| extension | aligned with the media | if the capturing device |
| | packets | is mobile (e.g., drone) |
| RTCP APP | Metadata that is dynamic | Heatmaps |
| | but does not require | |
| | alignment with the media | |
| | packets | |
| Media Inband | Metadata that is defined | SEI messages |
| | along with the codecs | MPEG-H audio |
| | | metadata SPS/PPS/VUI |
| ISO BMFF specific | Metadata is provided in | Fisheye metadata |
| signalling and new | the Movie Header | |
| schemes | | |
| ISO BMFF | Carried in metadata | Location metadata, |
| metadata tracks | tracks | Region of Interest, etc. |
| DASH MPD | Carriage of static or | Video codec, sample |
| | semi-static parameters | entry, etc. |

In some examples, content preparation device 20 and/or server device 60 may provide parameters as in-band with encapsulated video data, e.g., in a video elementary stream. Also, the video elementary stream provides an accurate semantical definition of the parameters as well as the value space. Example relevant inband functionalities are discussed below.

A sequence parameter set (SPS) and picture parameter set (PPS), especially video usability information (VUI) thereof, may carry relevant 2D video parameters (e.g., of Table 2).

The equirectangular projection SEI message (as defined in clause D.2.41.1 and D.3.41.1 of JCTVC-AB1005) provides information to enable remapping of color samples of the output decoded pictures onto a spherical coordinate space in angular coordinates (φ, θ) for use in omnidirectional video applications for which the viewing perspective is from the origin looking outward toward the inside of the sphere. The spherical coordinates are defined so that φ is the azimuth (longitude, increasing eastward) and θ is the elevation (latitude, increasing northward) as depicted in FIG. 3.

Content preparation device 20 and/or server device 60 may be configured to generate SEI messages according to the following example rules:
An SEI message with payload type 150 is generated
The erp_cancel_flag is set to 0
The erp_persistence flag is set to 1

When the video provides full 360 coverage and no Coverage parameter is present, then content preparation device 20/server device 60 may set the erp_explicit_coverage_range_flag to 0.

When the video does not provide full 360 coverage as indicated by the Coverage parameter, then, in some examples, content preparation device 20 and/or server device 60 may be configured to perform the following:
the erp_explicit_coverage_range_flag is set to 1
the erp_azimuth_min, erp_azimuth_max, erp_elevation_min and erp_elevation_max are set accordingly using the Coverage parameter values and the mapping defined in D.3.41.5 of [JCTVC-AB1005]
the region-wise packing SEI messages (as defined in as defined in clause D.2.41.3 and D.3.41.3 of [JCTVC-AB1005], more details in clause 4.3.5) should be generated in order to maximize the visible information in the encoded 2D image using the Cropping information parameters as follows
   The rwp_cancel_flag is set to 0
   The rwp_persistence_flag is set to 1
   num_packed_regions is set to 1
   proj_picture_width is set to FullWidthPixel
   proj_picture_height is set to FullHeightPixel
   packing_type[0] is set to 0
   proj_region_width[0] is set to FullWidthPixel−(Cropping.Left+Cropping.Right)
   proj_region_height[0] is set to FullHeightPixel−(Cropping.Top+Cropping.Bottom)
   proj_region_top[0] is set to Cropping.Top
   proj_region_left[0] is set to Cropping.Left
   transform_type[0] is set to 0
   packed_region_width[0] is set to FullWidthPixel−(Cropping.Left+Cropping.Right)
   packed_region_height[0] is set to FullHeightPixel−(Cropping.Top+Cropping.Bottom)
packed_region_top[0] is set to Cropping.Top
   packed_region_left[0] is set to Cropping.Left

When the video is stereoscopic, then content preparation device 20 and/or server device 60 may generate the frame packing and an appropriate frame packing arrangement SEI message (as defined in ISO/IEC 23008-2), e.g., as follows:
An SEI message with payload type 45 is generated
The frame_packing_arrangement_cancel_flag is set to 1
The frame_packing_arrangement_type is set to one of the following values: 3 or 4. For more details on the choice of one of the formats, see below.
The quincunx_sampling_flag is set to 0

Using frame-compatible plano-stereoscopic video formats means that the left-eye and right-eye images are arranged in a spatial multiplex, which results in a composite image that can be treated like a conventional 2D image. Annex A of TS 101 547-2 provides an informative overview of the frame compatible video formats and how a single 2D image can be generated if frame_packing_arrangement_type with a value of 3 or 4 is in use.

The region-wise packing SEI message provides information to enable remapping of the colour samples of the cropped output pictures onto projected pictures. For more details, refer to clauses D.2.41.3 and D.3.41.3 of JCTVC-AB1005.

ISO BMFF timed metadata tracks are available. Different information may be collected, e.g., partially from 3GPP and partially from MPEG.

When Location timed metadata is stored in the 3GPP File Format, a timed metadata track may be used with LocationSampleEntry box, as described in clause 6.12 of TS26.244. The presence of LocationSampleEntry may indicate that the metadata sample formats are the fields of the Location Information box in Table 8.10 of TS26.244 starting from the Role field, i.e., as shown in Table 7 below:

TABLE 7
Location Timed Metadata Sample Format

| Field | Type | Details | Value |
|---|---|---|---|
| Role | Unsigned int(8) | Non-negative value | |
| | | indicating role of location | |
| Longitude | Unsigned | Fixed-point value of the | |
| | int(32) | longitude | |
| Latitude | Unsigned | Fixed-point value of the | |
| | int(32) | latitude | |
| Altitude | Unsigned | Fixed-point value of the | |
| | int(32) | Altitude | |
| Astronomical_body | String | Text of astronomical body | |
| Additional_notes | String | Text of additional location- | |
| | | related information | |

For the definitions of these fields, see the definitions of the Location Information box in clause 8.2 of TS26.244.

For region of interest, the OMAF standard describes director's cut information, which may be relevant to the techniques of this disclosure.

Client device 40 may use any or all of the metadata discussed above, e.g., to select and retrieve appropriate media content and/or to determine how to properly retrieve, decode, process, and/or present retrieved or received media content.

In accordance with the techniques of this disclosure, content preparation device 20, server device 60, and/or client device 40 may be configured according to any or all of:
1) Rely on externally defined metadata and reference as appropriate.
2) If no externally defined metadata is yet available, but work is in progress or proprietary metadata exists, provide means that this data can be carried, but do not define the data for FLUS.
3) Use codec inband signaling for metadata signaling as the first option. Inband signaling provides the most robust way to be independent of the transport.
4) Expose inband signaling to the system level only if it is necessary and important for capability exposure, capability exchange, processing optimization or network-based processing.
5) Defer open issues for later phases, do not attempt to solve everything in the first phase and communicate with MPEG on open issues.

For SDP/RTP applications, source bundles may be signaled on application levels. Example SDP/RTP-based signaling is defined below in Table 8.

TABLE 8

Type

Video

| | |
|---|---|
| 2D-Video | Video Elementary Stream: SPS/PPS/VUI |
| | SDP parameters for video in MTSI/payload |
| | formats |
| Fisheye Video | SEI message [tbc], if not available send LS to |
| | MPEG New SDP parameter that indicates the |
| | presence of the SEI messages/scheme type. |
| Projected 360 Video | SEI messages in Elementary stream: ERP, |
| | Frame Packing Arrangement, etc. |
| | New SDP parameter that indicates the presence |
| | of the SEI messages/scheme type. |
| Packed Video Content | SEI messages for region-wise packing [tbc], |
| | if not sufficient, send LS to MPEG, and |
| | possibly tiles. |
| | Association between regions needs to be |
| | provided. |
| | New SDP parameter that indicates the |
| | presence of the SEI messages/scheme type. |
| Multistream Video | 2D Video Parameters |
| | Proprietary signaling |

Audio

| | |
|---|---|
| 2D Audio | Open |
| 3D Audio | Open |
| Multi-microphone | Open |

Metadata

| | |
|---|---|
| Location | Location information either provided SDP |
| | signaling or in an RTP extension header |
| Timing | SDP |
| | RTP and RTCP sender report |
| Processing Information | SDP |
| (e.g., stitching SW) | |
| Licensing information | SDP |
| Director's Cut | Undefined, not urgent for now (phase 2) |
| Heatmap | Undefined, not urgent for now (phase 2) |

Synchronization and Alignment

| | |
|---|---|
| Synchronization | RTP and RTCP sender reports |
| Spatial Alignment | Coordinate system adjustment (tbd) |
| | Inband rotation signalling |

For generic FLUS applications, source bundles may be signaled at the application level. Example FLUS-based signaling is defined below in Table 9.

TABLE 9

Type

Video

| | |
|---|---|
| 2D-Video | Video Elementary Stream: SPS/PPS/VUI |
| | System level information for capability |
| | exposure and negotiation |
| Fisheye Video | SEI message [tbc], if not available send LS to |
| | MPEG System level information for capability |
| | exposure and negotiation. |
| Projected 360 Video | SEI messages in Elementary stream: ERP, |
| | Frame Packing Arrangement, etc. |
| | System level information for capability |
| | exposure and negotiation. |
| Packed Video Content | SEI messages for region-wise packing [tbc], |
| | if not sufficient, send LS to MPEG, and |
| | possibly tiles. |
| | Association between regions needs to be |
| | provided. |
| | System level information for capability |
| | exposure and negotiation |
| Multistream Video | 2D Video Parameters |
| | Proprietary signaling |

Audio

| | |
|---|---|
| 2D Audio | Open |
| 3D Audio | Open |
| Multi-microphone | Open |

Metadata

| | |
|---|---|
| Location | Location information either provided |
| | dynamically with the source |
| Timing | Some wall-clock time associated with the |
| | production |
| Processing Information | Private fields for providing processing |
| (e.g., stitching SW) | information |
| Licensing information | Private fields for providing licensing |
| | information |
| Director's Cut | Undefined, not urgent for now (phase 2) |
| Heatmap | Undefined, not urgent for now (phase 2) |

Synchronization and Alignment

| | |
|---|---|
| Synchronization | Time alignment of audio and video |
| Spatial Alignment | Coordinate system adjustment (tbd) |
| | Inband rotation signalling |

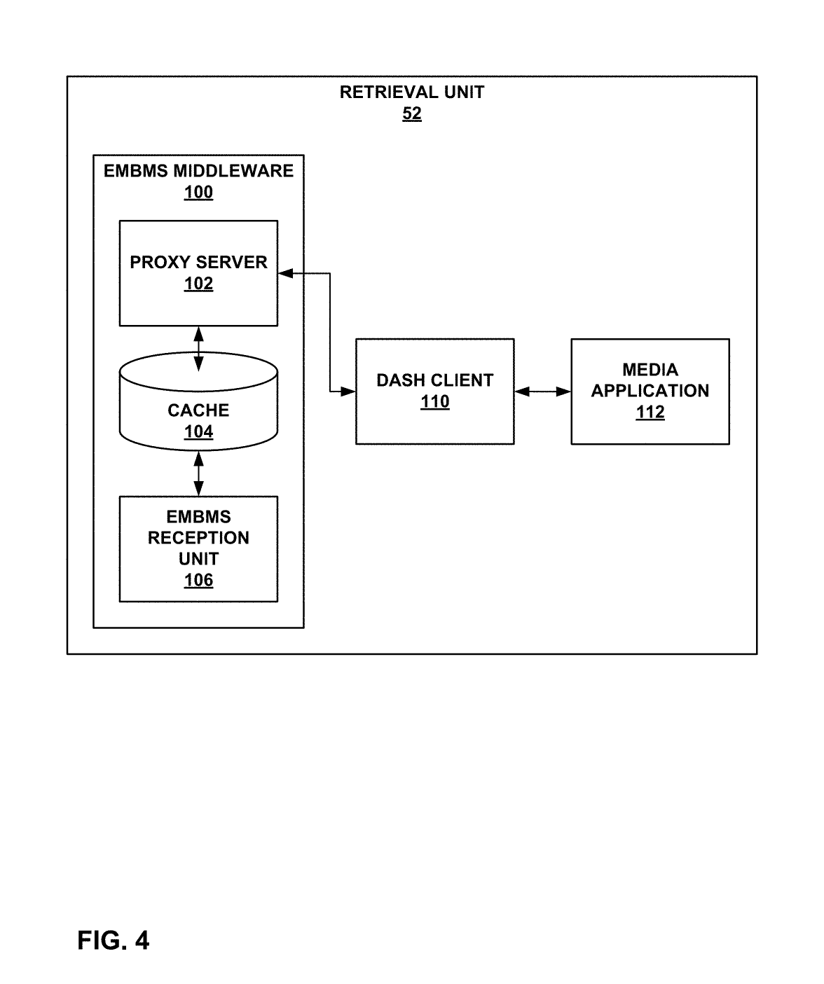

FIG. 4 is a block diagram illustrating an example set of components of retrieval unit 52 of FIG. 1 in greater detail. In this example, retrieval unit 52 includes eMBMS middleware unit 100, DASH client 110, and media application 112.

In this example, eMBMS middleware unit 100 further includes eMBMS reception unit 106, cache 104, and proxy server unit 102. In this example, eMBMS reception unit 106 is configured to receive data via eMBMS, e.g., according to File Delivery over Unidirectional Transport (FLUTE), described in T. Paila et al., “FLUTE—File Delivery over Unidirectional Transport,” Network Working Group, RFC 6726, November 2012, available at tools.ietf.org/html/rfc6726. That is, eMBMS reception unit 106 may receive files via broadcast from, e.g., server device 60, which may act as a BM-SC.

As eMBMS middleware unit 100 receives data for files, eMBMS middleware unit may store the received data in cache 104. Cache 104 may comprise a computer-readable storage medium, such as flash memory, a hard disk, RAM, or any other suitable storage medium.

Proxy server unit 102 may act as a server for DASH client 110. For example, proxy server unit 102 may provide a MPD file or other manifest file to DASH client 110. Proxy server unit 102 may advertise availability times for segments in the MPD file, as well as hyperlinks from which the segments can be retrieved. These hyperlinks may include a localhost address prefix corresponding to client device 40 (e.g., 127.0.0.1 for IPv4). In this manner, DASH client 110 may request segments from proxy server unit 102 using HTTP GET or partial GET requests. For example, for a segment available from link http://127.0.0.1/rep1/seg3, DASH client 110 may construct an HTTP GET request that includes a request for http://127.0.0.1/rep1/seg3, and submit the request to proxy server unit 102. Proxy server unit 102 may retrieve requested data from cache 104 and provide the data to DASH client 110 in response to such requests.

DASH client 110 may be configured according to any or all of the techniques of this disclosure as discussed above, alone or in any combination.

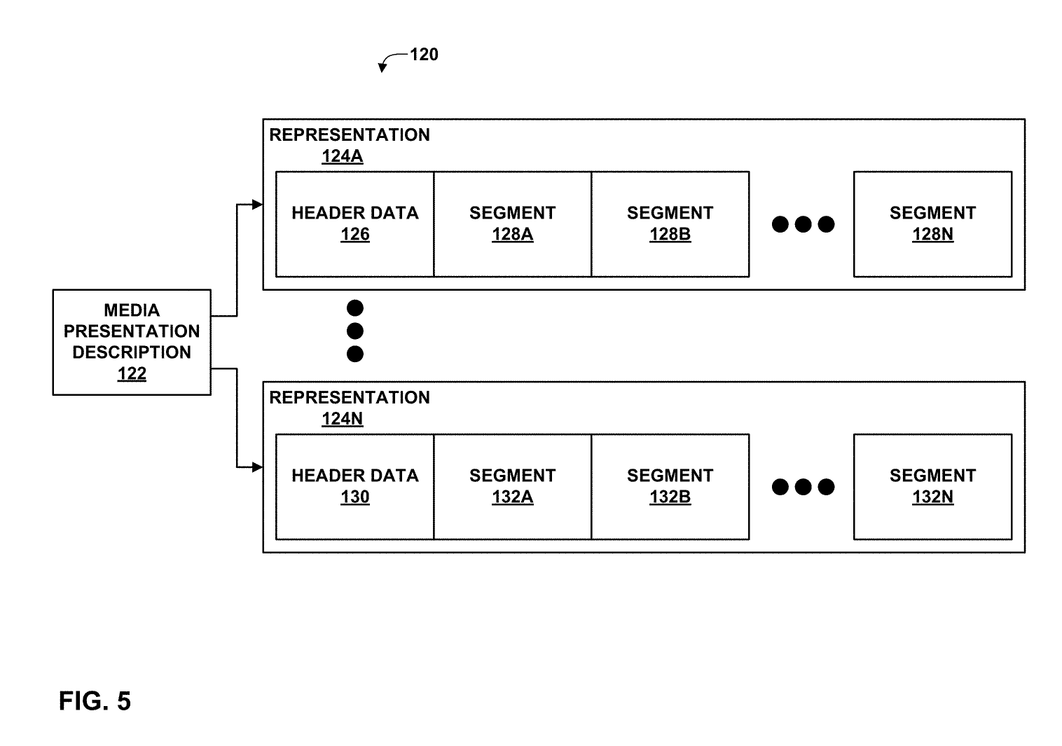

FIG. 5 is a conceptual diagram illustrating elements of example multimedia content 120. Multimedia content 120 may correspond to multimedia content 64 (FIG. 1), or another multimedia content stored in storage medium 62. In the example of FIG. 5, multimedia content 120 includes media presentation description (MPD) 122 and a plurality of representations 124A-124N (representations 124). Representation 124A includes optional header data 126 and segments 128A-128N (segments 128), while representation 124N includes optional header data 130 and segments 132A-132N (segments 132). The letter N is used to designate the last movie fragment in each of representations 124 as a matter of convenience. In some examples, there may be different numbers of movie fragments between representations 124.

MPD 122 may comprise a data structure separate from representations 124. MPD 122 may correspond to manifest file 66 of FIG. 1. Likewise, representations 124 may correspond to representations 68 of FIG. 4. In general, MPD 122 may include data that generally describes characteristics of representations 124, such as coding and rendering characteristics, adaptation sets, a profile to which MPD 122 corresponds, text type information, camera angle information, rating information, trick mode information (e.g., information indicative of representations that include temporal sub-sequences), and/or information for retrieving remote periods (e.g., for targeted advertisement insertion into media content during playback).

Header data 126, when present, may describe characteristics of segments 128, e.g., temporal locations of random access points (RAPs, also referred to as stream access points (SAPs)), which of segments 128 includes random access points, byte offsets to random access points within segments 128, uniform resource locators (URLs) of segments 128, or other aspects of segments 128. Header data 130, when present, may describe similar characteristics for segments 132. Additionally or alternatively, such characteristics may be fully included within MPD 122.

Segments 128, 132 include one or more coded video samples, each of which may include frames or slices of video data. Each of the coded video samples of segments 128 may have similar characteristics, e.g., height, width, and bandwidth requirements. Such characteristics may be described by data of MPD 122, though such data is not illustrated in the example of FIG. 5. MPD 122 may include characteristics as described by the 3GPP Specification, with the addition of any or all of the signaled information described in this disclosure.

Each of segments 128, 132 may be associated with a unique uniform resource locator (URL). Thus, each of segments 128, 132 may be independently retrievable using a streaming network protocol, such as DASH. In this manner, a destination device, such as client device 40, may use an HTTP GET request to retrieve segments 128 or 132. In some examples, client device 40 may use HTTP partial GET requests to retrieve specific byte ranges of segments 128 or 132.

MPD 122 may include data constructed according to any or all of the techniques of this disclosure, alone or in any combination.

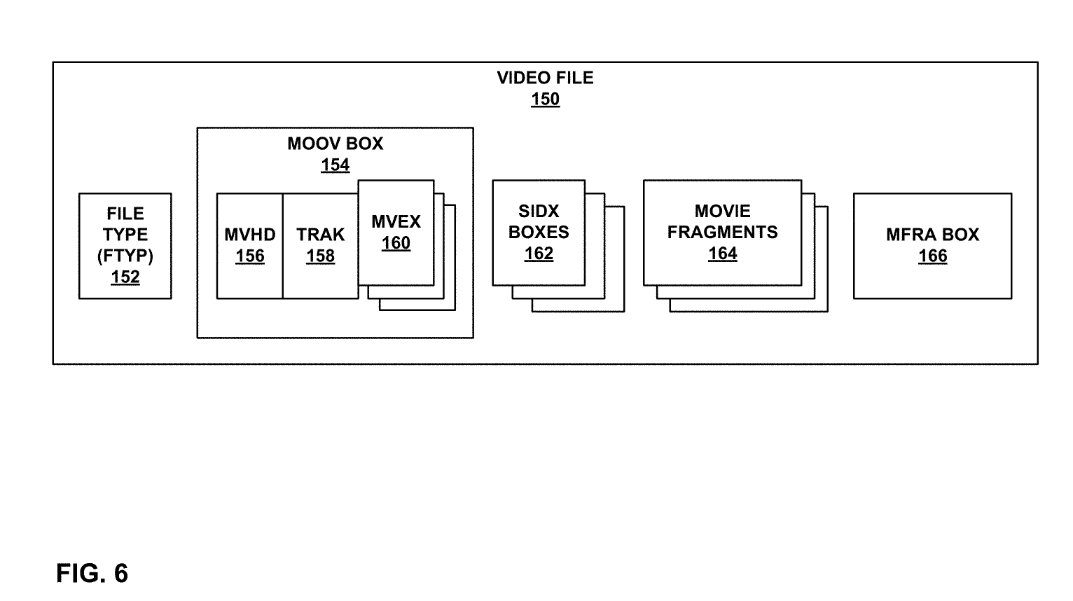

FIG. 6 is a block diagram illustrating elements of an example video file 150, which may correspond to a segment of a representation, such as one of segments 114, 124 of FIG. 5. Each of segments 128, 132 may include data that conforms substantially to the arrangement of data illustrated in the example of FIG. 6. Video file 150 may be said to encapsulate a segment. As described above, video files in accordance with the ISO base media file format and extensions thereof store data in a series of objects, referred to as “boxes.” In the example of FIG. 6, video file 150 includes file type (FTYP) box 152, movie (MOOV) box 154, segment index (sidx) boxes 162, movie fragment (MOOF) boxes 164, and movie fragment random access (MFRA) box 166. Although FIG. 6 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

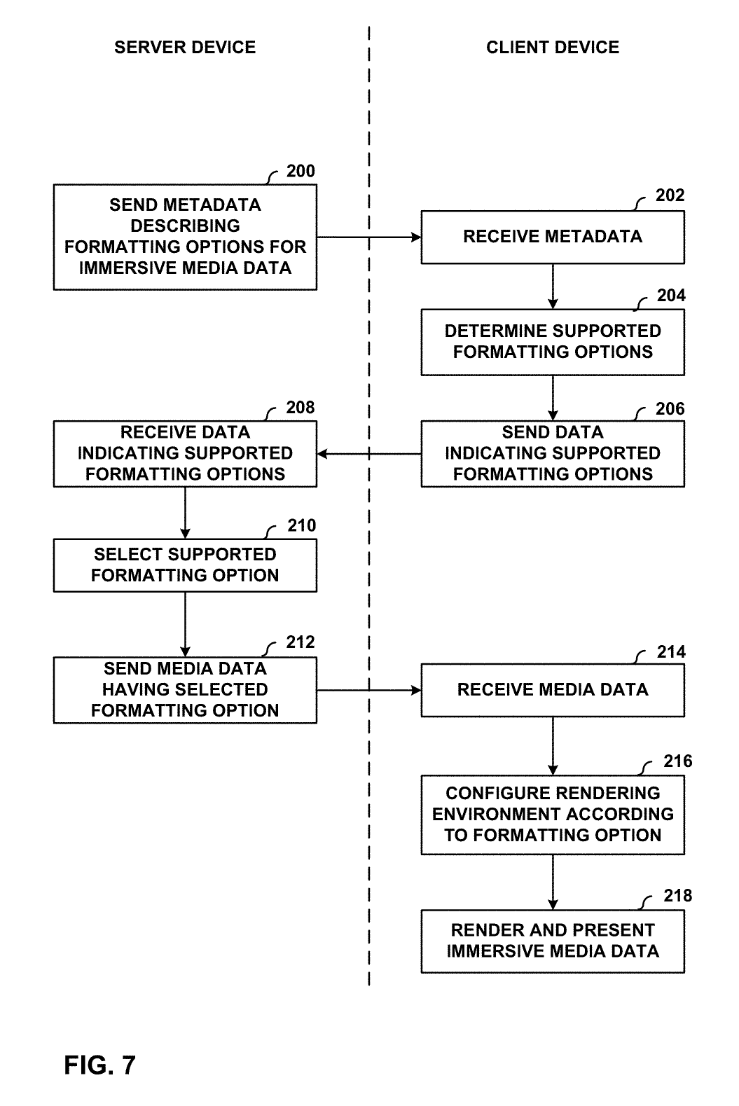

In some examples, a Segment, such as video file 150, may include an MPD update box (not shown) before FTYP box 152. The MPD update box may include information indicating that an MPD corresponding to a representation including video file 150 is to be updated, along with information for updating the MPD. For example, the MPD update box may provide a URI or URL for a resource to be used to update the MPD. As another example, the MPD update box may include data for updating the MPD. In some examples, the MPD update box may immediately follow a segment type (STYP) box (not shown) of video file 150, where the STYP box may define a segment type for video file 150. FIG. 7, discussed in greater detail below, provides additional information with respect to the MPD update box.

MOOV box 154, in the example of FIG. 6, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 5) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units which contains the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 6). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

FIG. 7 is a flowchart illustrating an example method for transferring media data including immersive media data between server device 60 and client device 40 according to the techniques of this disclosure. Although server device 60 and client device 40 of FIG. 1 are described for purposes of example, it should be understood that other devices may perform this or a similar method, such as content preparation device 20.

Initially, content preparation device 20 may prepare metadata describing formatting options for immersive media data. The metadata may be, for example, a parameter set (such as a picture parameter set (PPS) or sequence parameter set (SPS)), video usability information (VUI) of a parameter set, data of a manifest file such as a DASH MPD, SDP/RTP data, or the like. Server device 60 may then send the metadata describing the formatting options for the immersive media data (200). For example, client device 40 may initially request the metadata, e.g., using HTTP or RTP, and server device 60 may send the metadata in response to the request.

Client device 40 may then receive the metadata (202). Client device 40 may further determine supported formatting options (204). For example, client device 40 may determine whether video output 44 is capable of outputting video data formatted according to two-dimensional, fisheye, spherical projected 360, packed multi-cameras, and/or individual multi cameras schemes, in the case that the metadata indicates that these formatting options are available. Client device 40 may then send data indicating one or more of the formatting options that client device 206 supports (206).

Server device 60 may then receive the data indicating the supported formatting options (208). Server device 60 may select one of the supported formatting options (210) and send immersive media data having the selected formatting option (212) to client device 40.

Client device 40 may then receive the immersive media data (214). In addition, client device 40 may configure a rendering environment according to the selected formatting option (216). That is, client device 40 may cause a rendering unit thereof to render decoded media data in a manner appropriate to the formatting option. For example, if the immersive media data includes multistream video data, client device 40 may configure video output 44 to render two or more sets of video data as multiview video data. As another example, if the immersive media data is projected 360 video, client device 40 may configure video output 44 to rearrange decoded video data such that the decoded video data is properly projected according to, e.g., a spherical or cubical projection scheme. As yet another example, if the immersive media data is packed video content, client device 40 may unpack decoded video data according to a frame packing arrangement, e.g., horizontal packing, vertical packing, quincunx packing, or the like, to produce two or more pictures for each decoded frame of video data. Client device 40 may then render and present the immersive media data (218).

In this manner, FIG. 7 represents an example of a method of sending media data including immersive media data, the method including sending metadata that systematically describes different formatting options for the immersive media data to a client device, receiving, from the client device, data representing one or more of the formatting options that the client device supports for rendering the immersive media data, selecting a formatting option of the one or more of the formatting options that the client device supports, and sending the immersive media data having the selected formatting option to the client device.

FIG. 7 also represents an example of a method of receiving media data including immersive media data, the method including receiving, by a client device, metadata that systematically describes different formatting options for the immersive media data from a server device, determining, by the client device, one or more of the formatting options that the client device supports for rendering the immersive media data, sending, by the client device, to the server device, data representing the one or more of the formatting options that the client device supports for rendering the immersive media data, retrieving, by the client device, the immersive media data having one of the formatting options, and configuring, by the client device, a rendering environment according to the one of the formatting options to render the immersive media data.

The techniques of FIG. 7 may offer various improvements to the field of media data transmission. For example, by providing an indication of available formatting options in this manner, a client device can determine which of the formatting options to is supported, such that an appropriate selection of a formatting option can be made as part of a transmission protocol, such as DASH or SDP/RTP. Thus, the client device and the server device can improve bandwidth utilization, in that only appropriately formatted immersive media data will be sent to the client device. Likewise, the client device can use the selected formatting option to configure a rendering environment appropriately, such that the immersive media data can be properly rendered for presentation to a user.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of sending media data including immersive media data, the method comprising:
sending metadata that systematically describes different formatting options for the immersive media data to a client device;
receiving, from the client device, data representing one or more of the formatting options that the client device supports for rendering the immersive media data;
selecting a formatting option of the one or more of the formatting options that the client device supports; and
sending the immersive media data having the selected formatting option to the client device.

2. The method of claim 1, wherein the immersive media data comprises at least one of two-dimensional video data or multistream video data, and wherein sending the metadata comprises sending the metadata as part of at least one of a sequence parameter set (SPS) or a picture parameter set (PPS) of video data of the immersive media data.

3. The method of claim 2, wherein sending the metadata comprises sending the metadata as part of video usability information (VUI) of the SPS or PPS.

4. The method of claim 1, wherein the immersive media data comprises fisheye video, and wherein sending the metadata comprises sending the metadata as part of at least one of a supplemental enhancement information (SEI) message or a session description protocol (SDP) parameter indicating presence of the SEI message or scheme type.

5. The method of claim 1, wherein the immersive media data comprises projected 360 video, and wherein sending the metadata comprises sending at least one of a supplemental enhancement information (SEI) message of a video elementary stream of the immersive media data, ERP, frame packing arrangement, or a session description protocol (SDP) parameter indicating presence of the SEI message or scheme type.

6. The method of claim 1, wherein the immersive media data comprises packed video content, and wherein sending the metadata comprises sending at least one of a supplemental enhancement information (SEI) message including region wise packing information, metadata defining associations between regions, or a session description protocol (SDP) parameter indicating presence of the SEI message or scheme type.

7. The method of claim 1, wherein sending the metadata comprises sending location information in a session description protocol (SDP) or a Real-time Transport Protocol (RTP) extension header.

8. The method of claim 1, wherein sending the metadata comprises sending the metadata according to at least one of Session Description Protocol (SDP)/Real-Time Transport Protocol (RTP) or Dynamic Adaptive Streaming over HTTP (DASH).

9. A method of retrieving media data including immersive media data, the method comprising:
receiving, by a client device, metadata that systematically describes different formatting options for the immersive media data from a server device;
determining, by the client device, one or more of the formatting options that the client device supports for rendering the immersive media data;
sending, by the client device, to the server device, data representing the one or more of the formatting options that the client device supports for rendering the immersive media data;
retrieving, by the client device, the immersive media data having one of the formatting options; and
configuring, by the client device, a rendering environment according to the one of the formatting options to render the immersive media data.

10. The method of claim 9, wherein the immersive media data comprises at least one of two-dimensional video data or multistream video data, and wherein receiving the metadata comprises receiving the metadata as part of at least one of a sequence parameter set (SPS) or a picture parameter set (PPS) of video data of the immersive media data.

11. The method of claim 10, wherein receiving the metadata comprises receiving the metadata as part of video usability information (VUI) of the SPS or PPS.

12. The method of claim 9, wherein the immersive media data comprises fisheye video, and wherein receiving the metadata comprises receiving the metadata as part of at least one of a supplemental enhancement information (SEI) message or a session description protocol (SDP) parameter indicating presence of the SEI message or scheme type.

13. The method of claim 9, wherein the immersive media data comprises projected 360 video, and wherein receiving the metadata comprises receiving at least one of a supplemental enhancement information (SEI) message of a video elementary stream of the immersive media data, ERP, frame packing arrangement, or a session description protocol (SDP) parameter indicating presence of the SEI message or scheme type.

14. The method of claim 9, wherein the immersive media data comprises packed video content, and wherein receiving the metadata comprises receiving at least one of a supplemental enhancement information (SEI) message including region wise packing information, metadata defining associations between regions, or a session description protocol (SDP) parameter indicating presence of the SEI message or scheme type.

15. The method of claim 9, wherein receiving the metadata comprises receiving location information in a session description protocol (SDP) or a Real-time Transport Protocol (RTP) extension header.

16. The method of claim 9, wherein receiving the metadata comprises receiving the metadata according to at least one of Session Description Protocol (SDP)/Real-Time Transport Protocol (RTP) or Dynamic Adaptive Streaming over HTTP (DASH).

17. A device for transferring media data including immersive media data, the device comprising:
a memory configured to store the media data; and
one or more processors implemented in circuitry and configured to:
transfer metadata that systematically describes different formatting options for the immersive media data;
process data representing one or more of the formatting options that a client device supports for rendering the immersive media data; and
transfer the immersive media data having one of the formatting options that the client device supports.

18. The device of claim 17, wherein the immersive media data comprises at least one of two-dimensional video data or multistream video data, and wherein the one or more processors are configured to transfer the metadata as part of at least one of a sequence parameter set (SPS) or a picture parameter set (PPS) of video data of the immersive media data.

19. The device of claim 18, wherein the one or more processors are configured to transfer the metadata as part of video usability information (VUI) of the SPS or PPS.

20. The device of claim 17, wherein the immersive media data comprises fisheye video, and wherein the one or more processors are configured to transfer the metadata as part of at least one of a supplemental enhancement information (SEI) message or a session description protocol (SDP) parameter indicating presence of the SEI message or scheme type.

21. The device of claim 17, wherein the immersive media data comprises projected 360 video, and wherein the one or more processors are configured to transfer at least one of a supplemental enhancement information (SEI) message of a video elementary stream of the immersive media data, ERP, frame packing arrangement, or a session description protocol (SDP) parameter indicating presence of the SEI message or scheme type.

22. The device of claim 17, wherein the immersive media data comprises packed video content, and wherein the one or more processors are configured to transfer at least one of a supplemental enhancement information (SEI) message including region wise packing information, metadata defining associations between regions, or a session description protocol (SDP) parameter indicating presence of the SEI message or scheme type.

23. The device of claim 17, wherein the one or more processors are configured to transfer location information in a session description protocol (SDP) or a Real-time Transport Protocol (RTP) extension header.

24. The device of claim 17, wherein the one or more processors are configured to transfer the metadata according to at least one of Session Description Protocol (SDP)/Real-Time Transport Protocol (RTP) or Dynamic Adaptive Streaming over HTTP (DASH).

25. The device of claim 17, wherein the device comprises a server device, and wherein the one or more processors are configured to select the one of the formatting options that the client device supports.

26. The device of claim 17, wherein the device comprises the client device, and wherein the one or more processors are configured to configure a rendering environment according to the one of the formatting options to render the immersive media data.

27. A computer-readable storage medium having stored thereon instructions that, when executed, cause a processor to:
transfer metadata that systematically describes different formatting options for immersive media data included in media data;
process data representing one or more of the formatting options that a client device supports for rendering the immersive media data; and
transfer the immersive media data having one of the formatting options that the client device supports.

28. The computer-readable storage medium of claim 27, wherein the immersive media data comprises at least one of two-dimensional video data or multistream video data, and wherein the instructions cause the processor to transfer the metadata as part of at least one of a sequence parameter set (SPS) or a picture parameter set (PPS) of video data of the immersive media data.

29. The computer-readable storage medium of claim 28, wherein the one or more processors are configured to transfer the metadata as part of video usability information (VUI) of the SPS or PPS.

30. The computer-readable storage medium of claim 27, wherein the immersive media data comprises fisheye video, and wherein the instructions cause the processor to transfer the metadata as part of at least one of a supplemental enhancement information (SEI) message or a session description protocol (SDP) parameter indicating presence of the SEI message or scheme type.

31. The computer-readable storage medium of claim 27, wherein the immersive media data comprises projected 360 video, and wherein the instructions cause the processor to transfer at least one of a supplemental enhancement information (SEI) message of a video elementary stream of the immersive media data, ERP, frame packing arrangement, or a session description protocol (SDP) parameter indicating presence of the SEI message or scheme type.

32. The computer-readable storage medium of claim 27, wherein the immersive media data comprises packed video content, and wherein the instructions cause the processor to transfer at least one of a supplemental enhancement information (SEI) message including region wise packing information, metadata defining associations between regions, or a session description protocol (SDP) parameter indicating presence of the SEI message or scheme type.

33. The computer-readable storage medium of claim 27, wherein the instructions cause the processor to transfer location information in a session description protocol (SDP) or a Real-time Transport Protocol (RTP) extension header.

34. The computer-readable storage medium of claim 27, wherein the instructions cause the processor to transfer the metadata according to at least one of Session Description Protocol (SDP)/Real-Time Transport Protocol (RTP) or Dynamic Adaptive Streaming over HTTP (DASH).

35. The computer-readable storage medium of claim 27, wherein the processor is included in a server device, and wherein the instructions cause the processor to select the one of the formatting options that the client device supports.

36. The computer-readable storage medium of claim 27, wherein the processor is included in the client device, and wherein the instructions cause the processor to configure a rendering environment according to the one of the formatting options to render the immersive media data.

37. A device for transferring media data including immersive media data, the device comprising:
means for transferring metadata that systematically describes different formatting options for the immersive media data;
means for processing data representing one or more of the formatting options that a client device supports for rendering the immersive media data; and
means for transferring the immersive media data having one of the formatting options that the client device supports.
